(19) United States
(12) Patent Application Publication
(10) Pub. No.: US 2025/0355999 A1
(43) Pub. Date: Nov. 20, 2025

(54) LOG MANAGEMENT DEVICE, LOG MANAGEMENT METHOD, STORAGE MEDIUM STORING LOG MANAGEMENT PROGRAM, AND LOG MANAGEMENT SYSTEM

(71) Applicants: DENSO CORPORATION, Kariya-city (JP); TOYOTA JIDOSHA KABUSHIKI KAISHA, Toyota-shi (JP)

(72) Inventors: Tatsuro KAWAKAMI, Kariya-city (JP); Ryosuke MURAKAMI, Kariya-city (JP); Kunihiro MIYAUCHI, Toyota-shi (JP)

(21) Appl. No.: 19/203,253

(22) Filed: May 9, 2025

(30) Foreign Application Priority Data
May 17, 2024 (JP) 2024-081280

(51) Int. Cl. G06F 21/55

(52) U.S. Cl. CPC G06F 21/552; G06F 2221/034

(57) ABSTRACT

A log management device includes a detection log reception unit configured to receive a detection log indicating a detection result of a security sensor of an electronic control unit mounted on a vehicle, a liveness monitoring log reception unit configured to receive a liveness monitoring log indicating that the security sensor is operating, a liveness monitoring function detection log generation unit configured to generate a liveness monitoring function detection log indicating an operation start and an operation stop of the security sensor based on a reception status of the liveness monitoring log, and an output unit configured to output the liveness monitoring function detection log and the detection log received during a first period.

### CROSS REFERENCE TO RELATED APPLICATION

This application is based on Japanese Patent Application No. 2024-081280 filed on May 17, 2024, the disclosure of which is incorporated herein by reference.

### TECHNICAL FIELD

The present disclosure relates to a log management device, method, program, and system for managing security logs using liveness monitoring logs generated by security sensors of electronic control units (ECUs) mounted on mobile bodies such as automobiles.

### BACKGROUND

Various methods exist for detecting abnormalities occurring in vehicles and analyzing cyber-attacks based on the detected abnormalities. For example, a related art describes a method for detecting abnormalities caused by attacks on a network, collecting data on the detected abnormalities, and matching the combination of detected abnormal items with pre-specified abnormal detection patterns for each attack to identify the type of cyber-attack corresponding to the abnormality.

Additionally, another related art describes using the liveness signals of security sensors in conjunction with identifying the type of cyber-attack and estimating the attack route to improve the accuracy of identification and estimation.

### SUMMARY

A log management device includes: a detection log reception unit configured to receive a detection log indicating a detection result of a security sensor of an electronic control unit mounted on a vehicle; a liveness monitoring log reception unit configured to receive a liveness monitoring log indicating that the security sensor is operating; a liveness monitoring function detection log generation unit configured to generate a liveness monitoring function detection log indicating an operation start and an operation stop of the security sensor based on a reception status of the liveness monitoring log; and an output unit configured to output the liveness monitoring function detection log and the detection log received during a first period.

### BRIEF DESCRIPTION OF DRAWINGS

Objects, features and advantages of the present disclosure will become more apparent from the following detailed description made with reference to the accompanying drawings. In the drawings:

FIG. 1 is an explanatory diagram illustrating the arrangement of the log management device and a relationship with related equipment in each embodiment;

FIG. 2 is an explanatory diagram illustrating the arrangement of the log management device and a relationship with related equipment in each embodiment;

FIG. 3 is a block diagram illustrating an example configuration of the electronic control system in each embodiment;

FIG. 4 is a block diagram illustrating an example configuration of the electronic control unit in each embodiment;

FIG. 5 is an explanatory diagram illustrating a security log generated by the security sensors of the electronic control unit in each embodiment;

FIG. 6 is a block diagram illustrating an example configuration of the log management device in the first embodiment;

FIG. 7 is an explanatory diagram illustrating the operation of generating the liveness monitoring function detection log by the log management device in the first embodiment;

FIG. 8 is an explanatory diagram illustrating an example setting of the grouping period in the first embodiment;

FIG. 9 is an explanatory diagram illustrating the log to be transmitted in the first embodiment;

FIG. 10A is an explanatory diagram illustrating the log to be transmitted in the first embodiment;

FIG. 10B is an explanatory diagram illustrating the log to be transmitted in the first embodiment;

FIG. 11 is a diagram illustrating the information transmitted by the output unit in the first embodiment;

FIG. 12 is a flowchart illustrating the operation of the log management device in the first embodiment;

FIG. 13 is a block diagram illustrating an example configuration of the log analysis device in the first embodiment;

FIG. 14 is a block diagram illustrating an example configuration of the log management device in the second embodiment;

FIG. 15A is an explanatory diagram illustrating the log to be transmitted in the second embodiment;

FIG. 15B is an explanatory diagram illustrating the log to be transmitted in the second embodiment; and

FIG. 16 is a diagram illustrating the information transmitted by the output unit in the second embodiment.

### DETAILED DESCRIPTION

In recent years, technologies such as V2X, including vehicle-to-vehicle and vehicle-to-infrastructure communications, as well as driving assistance and autonomous driving control, have been attracting attention. Consequently, vehicles are now equipped with communication functions, advancing the so-called connected vehicle technology. As a result, the likelihood of vehicles being subjected to cyber-attacks, such as unauthorized access, has increased. Therefore, it is necessary to analyze cyber-attacks on vehicles and develop countermeasures.

The inventors have identified the following issues. The liveness signals are periodically transmitted from security sensors and are useful for confirming whether there are any abnormalities in the security sensors themselves by the device receiving the liveness signals. However, if the electronic control unit (ECU) or bus equipped with the security sensor has a sleep function, the interruption of the liveness signal does not necessarily indicate an abnormality in the security sensor. Additionally, in a log analysis device that analyzes the threat of cyber-attacks by analyzing logs, it is not always necessary to have all the liveness signals themselves. If the operation of the security sensor can be estimated from the reception status of the liveness signals, information regarding the estimation results is sufficient.

The present disclosure provides a log management device and the like that provide useful information for analyzing the threat of cyber-attacks to the log analysis device.

According to one aspect of the present disclosure, a log management device includes: a detection log reception unit configured to receive a detection log indicating a detection result of a security sensor of an electronic control unit mounted on a vehicle; a liveness monitoring log reception unit configured to receive a liveness monitoring log indicating that the security sensor is operating; a liveness monitoring function detection log generation unit configured to generate a liveness monitoring function detection log indicating an operation start and an operation stop of the security sensor based on a reception status of the liveness monitoring log; and an output unit configured to output the liveness monitoring function detection log and the detection log received during a first period.

According to this configuration described above, the log management device and the like of the present disclosure can provide useful information for analyzing the threat of cyber-attacks to the log analysis device. Additionally, it can reduce the communication volume between the log management device and the log analysis device.

Hereinafter, embodiments of the present disclosure will be described with reference to the drawings.

The effects described in the embodiments are the effects when having the configurations of the embodiments as examples of the present disclosure and are not necessarily the effects possessed by the present disclosure.

When there are multiple embodiments (including variations and examples, similarly hereinafter), the configurations disclosed in each embodiment are not closed to each embodiment alone but can be combined across embodiments. For example, the configuration disclosed in one embodiment may be combined with another embodiment. Additionally, the configurations disclosed in each of the multiple embodiments may be collected and combined.

### 1. Basic Configuration of Each Embodiment

(1) Arrangement of Log Management Device and Relationship with Related Equipment

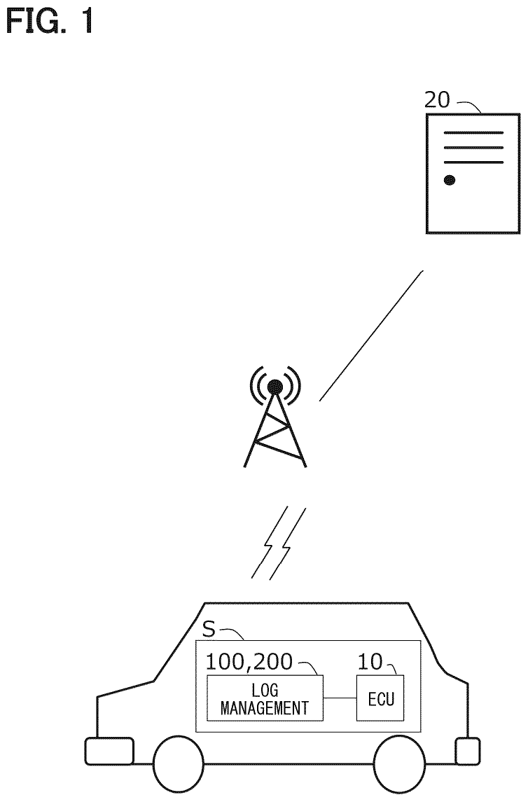

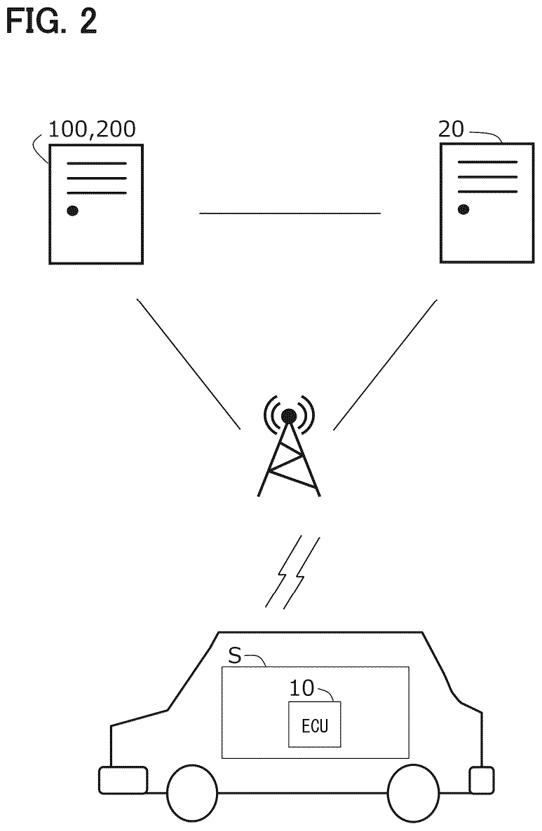

FIG. 1 and FIG. 2 are diagrams explaining the arrangement of the log management device and its relationship with related equipment in each embodiment. For example, as shown in FIG. 1, the log management device 100 or log management device 200 (hereinafter collectively referred to as log management device 100, and the like) is “mounted” on a “vehicle” along with the electronic control unit (ECU) 10 that constitutes the electronic control system S. Alternatively, as shown in FIG. 2, the ECU 10 that constitutes the electronic control system S is “mounted” on the “vehicle,” and the log management device 100 and the like is realized as a server device or the like provided outside the vehicle. In the embodiments described later, the case where the log management device 100 and the like is mounted on the vehicle as shown in FIG. 1 will be explained. Even in the case where the log management device 100 and the like is not mounted on the vehicle as shown in FIG. 2, the communication method with the ECU 10 is different, but otherwise, it is the same as each embodiment, so the descriptions of each embodiment are referenced.

“Vehicle” refers to a movable object, and the moving speed is arbitrary. It also includes cases where the vehicle is stationary. For example, it includes automobiles, motorcycles, bicycles, and objects mounted on these, but is not limited to these.

“Mounted” includes cases where it is directly fixed to the vehicle, as well as cases where it is not fixed to the vehicle but moves together with the vehicle. For example, it includes cases where a person riding in the vehicle possesses it, or it is mounted on cargo placed in the vehicle.

The log management device 100 and the like is connected to the “electronic control unit” (hereinafter referred to as ECU) that constitutes the electronic control system. The log management device 100 and the like is a device that acquires and manages security logs generated by security sensors mounted on multiple ECUs 10 that constitute the electronic control system S. Here, “electronic control unit” may refer to a physically independent electronic control unit or a virtualized electronic control unit realized using virtualization technology.

The log analysis device 20 is provided outside the vehicle and receives security logs from the log management device 100 and the like and analyzes the logs to detect and analyze cyber-attacks. The log analysis device 20 may be referred to as a Security Operations Center (SOC).

In FIG. 1, the electronic control system S and the log analysis device 20 are connected via a communication network using wireless communication methods such as IEEE 802.11 (Wi-Fi), IEEE 802.16 (WiMAX), W-CDMA (Wideband Code Division Multiple Access), HSPA (High Speed Packet Access), LTE (Long Term E volution), LTE-A (Long Term Evolution Advanced), 4G, 5G, or the like. Alternatively, DSRC (Dedicated Short Range Communication) can be used. When the vehicle is parked in a parking lot or housed in a repair shop, a wired communication method can be used instead of a wireless communication method. For example, LAN (Local Area Network), the Internet, or fixed telephone lines can be used. Additionally, a line combining wireless and wired communication methods may be used. For example, the electronic control system S and the base station device in the cellular system may be connected by a wireless communication method such as 4G, and the base station device and the log analysis device 20 may be connected by a wired communication method such as the core line of the communication carrier or the Internet. A gateway device may be provided at the contact point between the core line and the Internet.

In FIG. 2, the electronic control system S and the log management device 100 and the like provided outside the vehicle are also connected via a communication network using the aforementioned wireless or wired communication methods. In FIG. 2, the log management device 100 and the like and the log analysis device 20 are described as separate devices connected by a communication network, but the log management device 100 and the like and the log analysis device 20 may be implemented as the same device.

### (2) Configuration of the Electronic Control System S

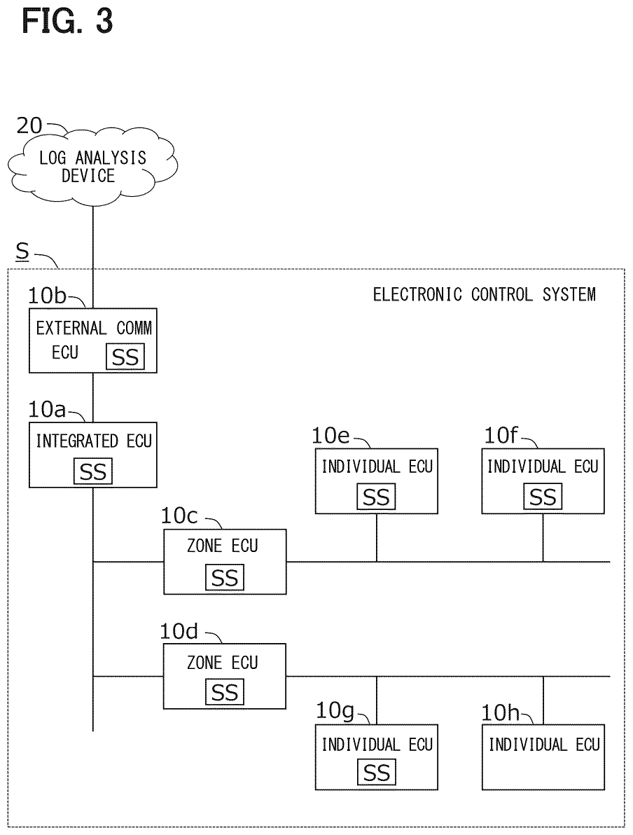

FIG. 3 is a diagram showing an example configuration of the electronic control system S. The electronic control system S includes multiple ECUs 10 and an in-vehicle network connecting them. FIG. 3 illustrates eight ECUs (ECU 10a to ECU 10h), but the electronic control system S can include any number of ECUs. In the following description, when describing the entire single or multiple electronic control units collectively, it is referred to as ECU 10 or each ECU 10. When specifying individual electronic control units, it is referred to as an ECU 10a, an ECU 10b, an ECU 10c, or the like.

In the case of FIG. 3, each ECU 10 is connected via an in-vehicle communication network such as CAN (Controller Area Network) or LIN (Local Interconnect Network). Alternatively, they may be connected using any communication method, wired or wireless, such as Ethernet, Wi-Fi, Bluetooth, or the like. The term “connected” means a state where data exchange is possible, including cases where different hardware is connected via a wired or wireless communication network, as well as cases where virtual ECUs (also known as virtual machines) realized on the same hardware are virtually connected.

The electronic control system S shown in FIG. 3 includes an integrated ECU 10a, an external communication ECU 10b, zone ECUs 10c, 10d, and individual ECUs 10e to 10h (that is, 10e, 10f, 10g, and 10h).

The integrated ECU 10a has the function of controlling the entire electronic control system S and serves as a gateway ECU that mediates communication between the ECUs. The integrated ECU 10a is also referred to as a gateway ECU (G-ECU) or a mobility computer (MC). Additionally, the integrated ECU 10a may be a relay device or a gateway device.

The external communication ECU 10b is an ECU with a communication unit that communicates with the log analysis device 20 provided outside the vehicle. The communication method used by the external communication ECU 10b is the aforementioned wireless or wired communication methods. Multiple external communication ECUs 10b may be provided to realize multiple communication methods. Alternatively, the integrated ECU 10a may include the functions of the external communication ECU 10b.

The zone ECUs 10c and 10d are ECUs with gateway functions appropriately arranged according to the location or function of the individual ECUs. For example, the zone ECU 10c is an ECU with a gateway function that mediates communication between the individual ECUs 10e and 10f arranged at the front of the vehicle and other ECUs 10. The zone ECU 10d is an ECU with a gateway function that mediates communication between the individual ECUs 10g and 10h arranged at the rear of the vehicle and other ECUs 10.

The individual ECUs 10e to 10h can be configured with ECUs having any function. For example, they may include drive system electronic control units that control the engine, steering, brakes and the like body system electronic control units that control meters, power windows and the like information system electronic control units such as navigation devices, or safety control system electronic control units that control to prevent collisions with obstacles or pedestrians. Additionally, the ECUs may be classified into master and slave rather than being in parallel.

In the electronic control system S of FIG. 3, security sensors are mounted on each ECU 10 except for ECU 10h (abbreviated as SS in the figure). Thus, it is not necessary for all ECUs 10 constituting the electronic control system S to have security sensors. The logs generated by the security sensors will be described later.

In each embodiment, the log management device 100 and the like is described as being provided in the integrated ECU 10a as an example. However, the log management device 100 and the like may be provided in the external communication ECU 10b, zone ECUs 10c to 10d, or individual ECUs 10e to 10h. When provided in one of the individual ECUs 10e to 10h, it may be desirable to have a dedicated ECU to realize the log management device 100, and the like.

### (3) Detection Logs and Liveness Monitoring Logs

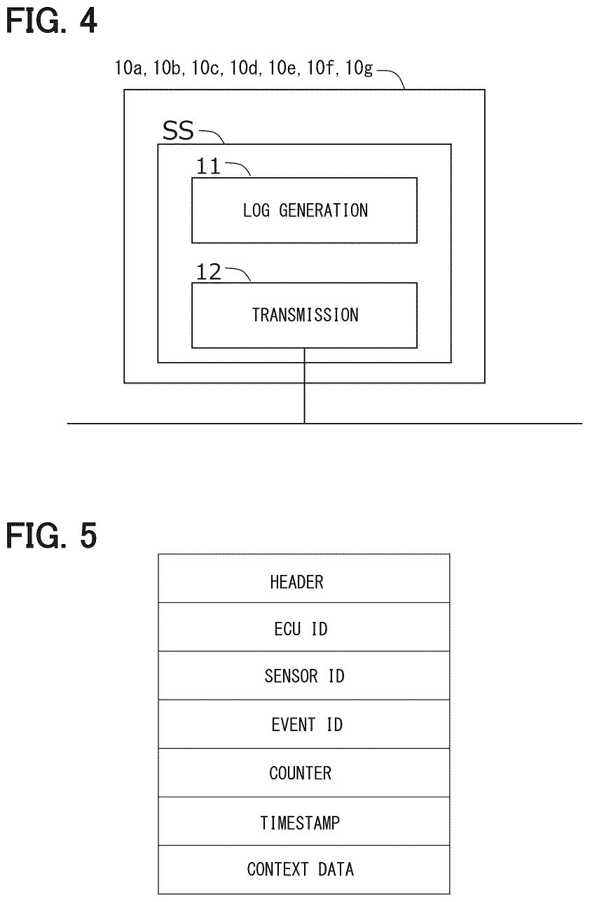

FIG. 4 is a block diagram showing the configuration of ECUs 10a to 10g equipped with security sensors. The ECUs 10a to 10g have a log generation unit 11 and a transmission unit 12.

The log generation unit 11 generates two types of security logs: detection logs and liveness monitoring logs. FIG. 5 shows specific examples of a security log. Security logs have fields for ECU ID indicating the identification information of the ECU 10 equipped with the security sensor, sensor ID indicating the identification information of the security sensor, event ID indicating the identification information of the security event, a counter indicating the number of occurrences of the event, a timestamp indicating the occurrence time of the event, and context data showing the details of the security sensor's output. Security logs may also have a header storing information indicating the protocol version and the state of each field. An event refers to the target or phenomenon detected by the security sensor.

Detection logs are security logs generated when the security sensor detects an abnormality, indicating the detection result of the security sensor. For example, detection logs are generated when an abnormality caused by a cyber-attack on each ECU 10 equipped with a security sensor is detected. In other words, the timing of generating detection logs is when an abnormality is detected. However, detection logs may also be generated when the security sensor detects that it is normal, in addition to when the security sensor detects an abnormality.

On the other hand, liveness monitoring logs are security logs indicating that the security sensor is “operating.” Liveness monitoring logs are generated to utilize the fact that the security sensor is operating if there is evidence of log generation. Liveness monitoring logs are also called liveness signals, keep-alive information, or heartbeat information. Here, “indicating that it is operating” means that it is sufficient to directly or indirectly identify that the security sensor is operating.

Liveness monitoring logs may also have the configuration shown in FIG. 5. In this case, for example, by setting a unique value for the liveness monitoring log in the event ID, it can be identified as a liveness monitoring log. For example, if the event ID is composed of 16 bits, setting the upper 4 bits to 1 (i.e., in hexadecimal notation, 0xF *** where * is any number) can indicate that it is a liveness monitoring log. Additionally, IDs other than the event ID, such as ECU ID or sensor ID, or any combination of the three IDs, may be assigned different IDs from detection logs.

Liveness monitoring logs may not have a context data field. However, by providing a context data field and storing information indicating that it is a liveness monitoring log in the context data, it can be identified as a liveness monitoring log. Additionally, the context data may store unique information of the security sensor, configuration information of the security sensor, or other meaningful information.

The timing of generating liveness monitoring logs is unrelated to the detection of abnormalities by the security sensor. For example, liveness monitoring logs are generated at regular intervals, such as every ten seconds or every minute. Alternatively, in addition to this, liveness monitoring logs may be generated at specific timings, such as when the vehicle's ignition is turned ON. The regular interval may always be constant or may be determined by conditions.

In each embodiment, liveness monitoring logs are generated and transmitted by the security sensor, but alternatively, another process or another ECU 10 monitoring the security sensor may generate and transmit the monitoring results of the security sensor's operation status as liveness monitoring logs.

Returning to FIG. 4, the transmission unit 12 transmits the security logs generated by the log generation unit 11 to the log management device 100 and the like via the in-vehicle network. When the security sensor and the log management device 100 and the like are mounted on the same ECU 10, they are directly output to the hardware or software realizing the log management device 100 and the like without going through the in-vehicle network.

Security logs generated by the security sensor are called SEv, and filtered qualified security logs are called QSEv. For example, the security sensor generates SEv and reports it to the intrusion detection system manager (IdsM), and when SEv passes the certified filter and meets the specified criteria in IdsM, it is sent outside the vehicle as QSEv by the intrusion detection reporter. The security logs in each embodiment include both SEv and QSEv. When the security log is QSEv, the range including the intrusion detection system manager (IdsM) corresponds to the log generation unit 11. The intrusion detection reporter corresponds to the transmission unit 12.

### 2. First Embodiment

### (1) Configuration of Log Management Device 100

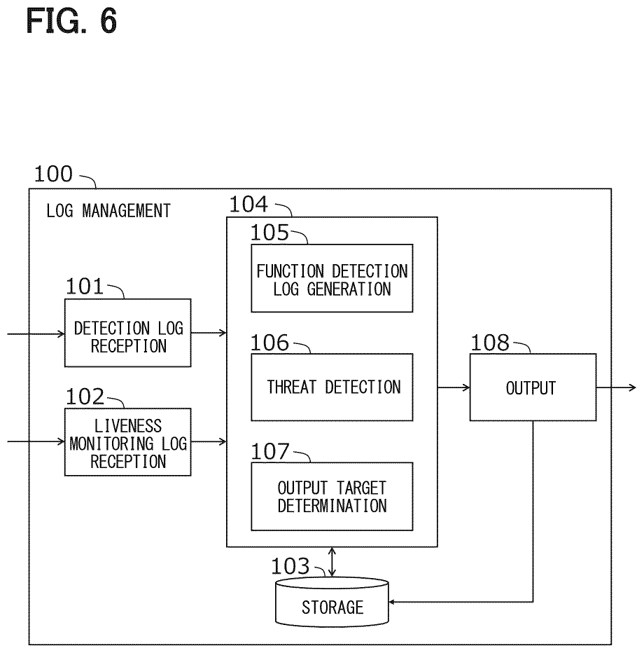

FIG. 6 is a block diagram showing the configuration of the log management device 100 in this embodiment. The log management device 100 includes a detection log reception unit 101, a liveness monitoring log reception unit 102, a storage unit 103, a control unit 104, and an output unit 108. The control unit 104 implements a liveness monitoring function detection log generation unit 105, a threat detection unit 106, and an output target determination unit 107 through hardware and/or software.

The log management device 100 can be configured with a general-purpose CPU (Central Processing Unit), a volatile memory such as RAM, a non-volatile memory such as ROM, a flash memory, or hard disk, various interfaces, and an internal bus connecting these components. By executing software on this hardware, the functions of each functional block described in FIG. 6 can be implemented. The same applies to the log analysis device 20 and the log management device 200 in the second embodiment.

The detection log reception unit 101 receives detection logs indicating the detection results of the security sensors of the ECU 10. Detection logs from security sensors mounted on ECUs 10 other than the integrated ECU 10a where the log management device 100 is mounted are acquired via the in-vehicle network, while detection logs from security sensors mounted on the integrated ECU 10a are acquired directly without going through the in-vehicle network.

The liveness monitoring log reception unit 102 receives liveness monitoring logs. The detection log reception unit 101 and the liveness monitoring log reception unit 102 may be implemented as a single reception unit.

The storage unit 103 stores the detection logs received by the detection log reception unit 101 and the liveness monitoring logs received by the liveness monitoring log reception unit 102. The storage unit 103 can be an external storage device (hard disk, USB memory, CD/BD, or the like) or an internal storage device (RAM, or the like). It can be either volatile or non-volatile. The storage unit 103 also stores the liveness monitoring function detection logs and detection logs determined by the output target determination unit 107 described later.

The liveness monitoring function detection log generation unit 105 generates liveness monitoring function detection logs indicating the start and stop of the security sensor's operation based on the “reception status” of the liveness monitoring logs in the liveness monitoring log reception unit 102. More specifically, the liveness monitoring function detection log generation unit 105 generates an operation stop detection log, which is a liveness monitoring function detection log, when the liveness monitoring logs are not received for a predetermined period (corresponding to the “second period”). Additionally, it generates an operation start detection log, which is a liveness monitoring function detection log, when the liveness monitoring logs are first received or received again after generating the operation stop detection log. Here, “reception status” may refer to the reception status of the liveness monitoring logs themselves or the content of the liveness monitoring logs.

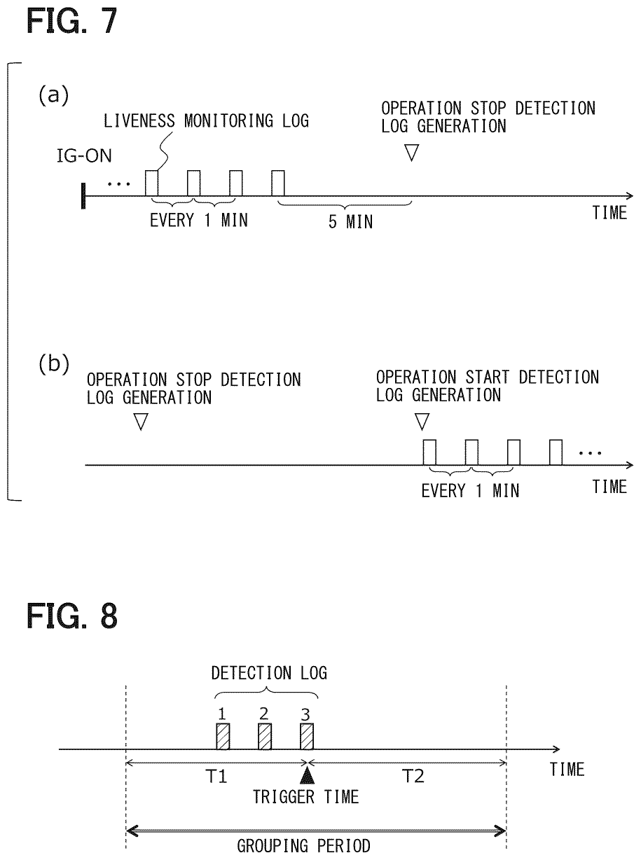

FIG. 7 is a diagram explaining the operation of the liveness monitoring function detection log generation unit 105. In a part (a) of FIG. 7, the liveness monitoring log reception unit 102 receives liveness monitoring logs every minute. When the liveness monitoring logs are not received for a predetermined period (corresponding to the “second period”), for example, five minutes, an operation stop detection log is generated. In a part (b) of FIG. 7, the liveness monitoring log reception unit 102 does not receive liveness monitoring logs for a while after generating the operation stop detection log. Then, when the liveness monitoring log reception unit 102 receives the liveness monitoring logs again, an operation start detection log is generated.

The predetermined period (corresponding to the “second period”) is preferably “longer than” the grouping period (corresponding to the “first period”). However, the difference between the two is preferably small. For example, the former is set to five minutes and the latter to four minutes and fifty seconds, making the difference within ten seconds. Here, “longer than” includes cases where the predetermined period is the same (≥) and cases where it is not included (≥).

The operation stop detection log and operation start detection log may also have the configuration shown in FIG. 5. For example, by setting unique values for the operation stop detection log and operation start detection log in the event ID, they can be identified as such.

It may be desirable to include information in the context data of the operation stop detection log and operation start detection log that identifies the security sensor that generated the liveness monitoring logs causing these logs. For example, the ECU ID, sensor ID, and event ID indicated by the liveness monitoring logs, or at least one of these, may be included. This allows the generation of operation stop detection logs and operation start detection logs for each ECU 10 or security sensor.

Additionally, the latest time when the liveness monitoring logs were received may be included in the operation stop detection log. The time when the liveness monitoring logs were received may be included in the operation start detection log.

The threat detection unit 106 determines whether the single or multiple detection logs received by the detection log reception unit 101 meet predetermined conditions. For example, a pattern matching table describing the relationship between combinations of abnormalities indicated by the detection logs and corresponding cyber-attacks is stored in the storage unit 103. The threat detection unit 106 determines whether the single or multiple detection logs received by the detection log reception unit 101 match the patterns described in the pattern matching table. If they match, it is estimated that there is a threat of a cyber-attack. Examples of predetermined conditions described in the pattern matching table include receiving a specific combination of detection logs or receiving a specific detection log a certain number of times within a predetermined period, but are not limited to these.

The output target determination unit 107 determines the range of security logs to be transmitted from the output unit 108 described later when the threat detection unit 106 determines that the predetermined conditions are met. The output destination is either the log analysis device 20 or the storage unit 103. In the former case, the transmission target is determined. In the latter case, the storage target is determined. Whether to transmit to the log analysis device 20 or output and store in the storage unit 103 can be determined by any criteria. This embodiment describes the case of transmitting to the log analysis device 20 as an example, but the operation in the case of outputting to the storage unit 103 is basically the same.

In this embodiment, the output target determination unit 107 sets the grouping period (corresponding to the “first period”) as the temporal range of the detection logs to be transmitted. Specifically, when the threat detection unit 106 determines that the detection logs meet the predetermined conditions, the reception time of the detection log is set as the trigger time. In the case of a combination of multiple detection logs, the reception time of the last received detection log is set as the trigger time. The grouping period is then set based on the trigger time.

FIG. 8 is a diagram explaining an example of setting the grouping period. In FIG. 8, it is assumed that the predetermined conditions are met by three detection logs. In this case, the reception time of the last received detection log is set as the trigger time. Then, a period T1 before the trigger time and a period T2 after the trigger time are set, and these combined are defined as the grouping period. It may be desirable to predetermine the lengths of periods T1 and T2 according to the type of cyber-attack, but they can also be determined by other methods.

The output target determination unit 107 determines the liveness monitoring function detection logs generated by the liveness monitoring function detection log generation unit 105 and the detection logs received by the detection log reception unit 101 during the grouping period as the security logs to be transmitted from the output unit 108. In this embodiment, the liveness monitoring function detection log to be transmitted is the most recent liveness monitoring function detection log generated “before the trigger time.” Here, “before the trigger time” includes both cases where the trigger time is included (≥) and not included (≥).

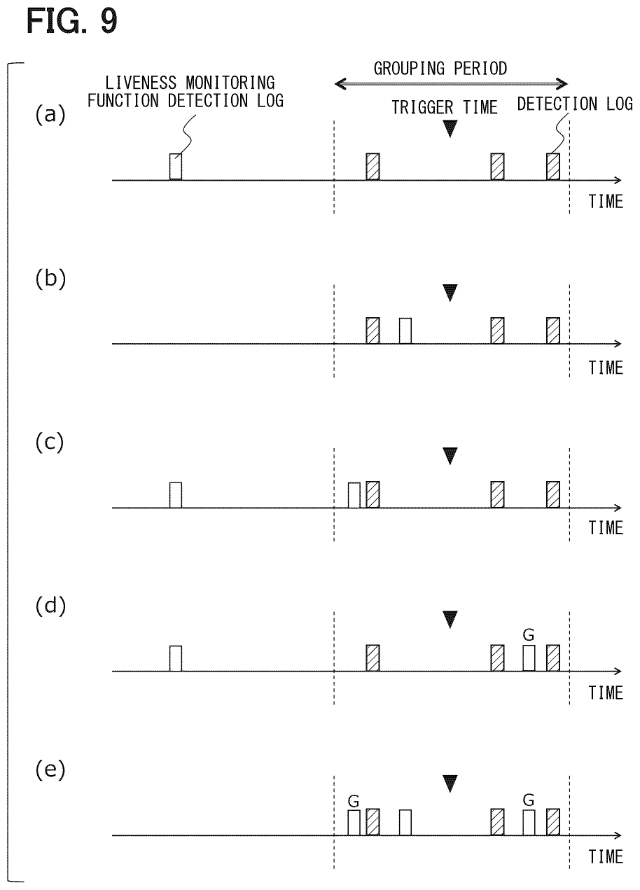

FIG. 9 is an example of liveness monitoring function detection logs to be transmitted. First, in a part (a) of FIG. 9 to a part (e) of FIG. 9, all detection logs within the grouping period are subject to transmission. These detection logs include those determined by the threat detection unit 106 to meet the predetermined conditions.

The part (a) of FIG. 9 shows the case where the most recent liveness monitoring function detection log generated before the trigger time was generated before the grouping period. In this case, when the liveness monitoring function detection log is an operation start detection log, it indicates that the security sensor is operating during the grouping period. When the liveness monitoring function detection log is an operation stop detection log, it indicates that the security sensor is stopped during the grouping period. A part (b) of FIG. 9 shows the case where the most recent liveness monitoring function detection log generated before the trigger time was generated within the grouping period. In this case, if the liveness monitoring function detection log is an operation start detection log, it indicates that the security sensor was stopped at the start of the grouping period but has been operating since the generation of the operation start detection log. In other words, as shown in the part (a) of FIG. 9 and the part (b) of FIG. 9, as long as it is before the trigger time, it does not matter whether the liveness monitoring function detection log was generated within the grouping period or before it.

In the case of the part (b) of FIG. 9, the most recent liveness monitoring function detection log generated before the start of the grouping period may also be subject to transmission. That is, as shown in a part (c) of FIG. 9, two liveness monitoring function detection logs may be subject to transmission. Additionally, in the cases of the part (a) of FIG. 9 and the part (b) of FIG. 9, other liveness monitoring function detection logs generated within the grouping period may be subject to transmission as regular detection logs. For example, as shown in a part (d) of FIG. 9, a liveness monitoring function detection log generated within the grouping period and after the trigger time (log G in the figure) may be subject to transmission as a regular detection log. Also, as shown in the part (e) of FIG. 9, a liveness monitoring function detection log other than the most recent one generated before the trigger time, but generated within the grouping period (log G in the figure), may be subject to transmission as a regular detection log.

In FIG. 9, the focus is on a single ECU 10 or security sensor, but typically, there are multiple ECUs and multiple security sensors. In such cases, the transmission targets are determined for each ECU 10 or security sensor.

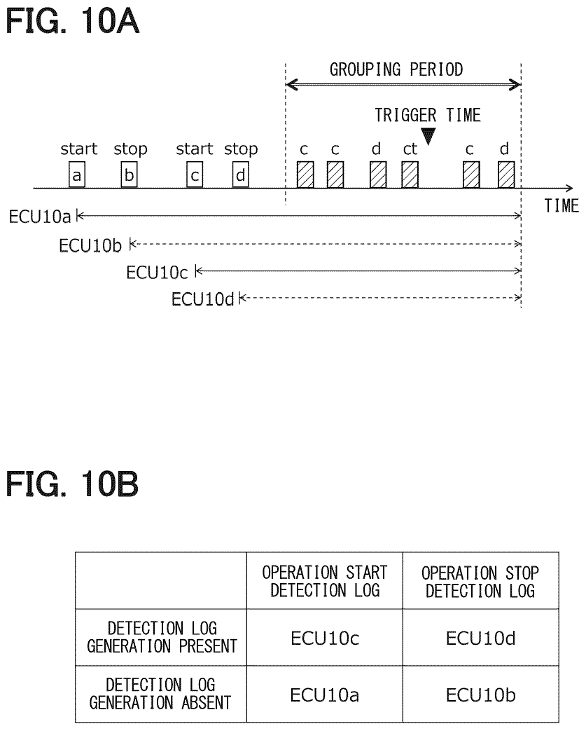

FIG. 10A is an example of security logs to be transmitted when there are four ECUs: ECU 10a, ECU 10b, ECU 10c, and ECU 10d. In the figure, operation start detection logs among the liveness monitoring function detection logs are labeled as “start,” and operation stop detection logs are labeled as “stop.” The letters a, b, c, and d attached to the liveness monitoring function detection logs and detection logs indicate which ECU generated the logs.

In FIG. 10A, it is assumed that the trigger time and the grouping period are set based on the detection log ct that meets the predetermined conditions. Here, the most recent liveness monitoring function detection logs generated before the trigger time are: operation start detection log a for ECU 10a, operation stop detection log b for ECU 10b, operation start detection log c for ECU 10c, and operation stop detection log d for ECU 10d. Therefore, these liveness monitoring function detection logs are determined as transmission targets. Additionally, detection logs received during the grouping period are also determined as transmission targets. In FIG. 10A, the detection logs included in the grouping period are those received from ECU 10c and ECU 10d. The detection logs may include those generated by ECUs 10 other than ECU 10a to ECU 10d. FIG. 10B will be described later as a function of the log analysis device 20.

Returning to FIG. 6, the output unit 108 outputs the security logs determined by the output target determination unit 107. In other words, if the output destination is the log analysis device 20, the output unit 108 transmits the logs to the log analysis device 20. If the output destination is the storage unit 103, the output unit 108 outputs the logs to the storage unit 103, which then stores the security logs. In this embodiment, the case of transmitting to the log analysis device 20 is used as an example for explanation.

When the output unit 108 transmits security logs to the log analysis device 20, the output unit 108 transmits all the security logs determined by the output target determination unit 107. However, the output unit 108 may alternatively transmit only a part of these logs. The range of logs to be transmitted can be determined by the output target determination unit 107 or the output unit 108, or it can be determined by an external device such as a diagnostic device or an external server.

For example, if the log management device 100 is implemented in the integrated ECU 10a, the output unit 108 transmits the logs to the log analysis device 20 via the external communication ECU 10b. In this embodiment, the liveness monitoring function detection logs and the detection logs received during the grouping period (corresponding to the “first period”) are transmitted. Preferably, the liveness monitoring function detection log to be transmitted is the most recent one generated before the trigger time.

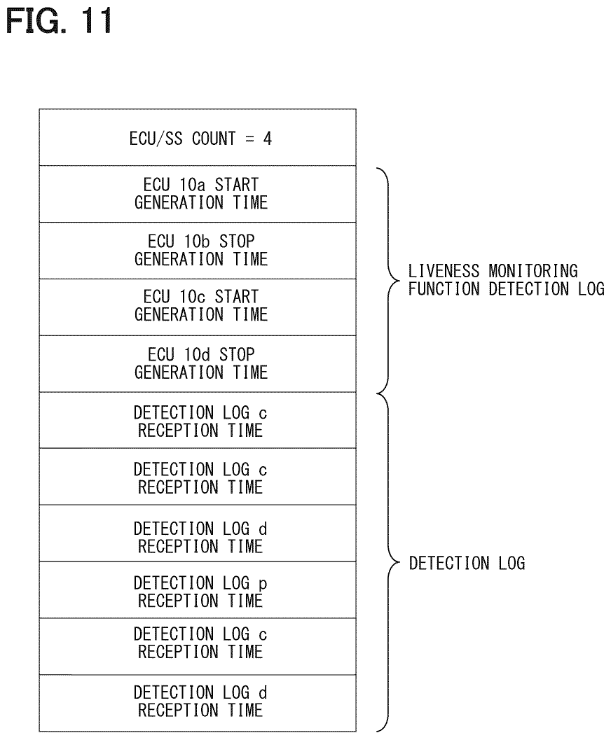

FIG. 11 is an example of the information transmitted by the output unit 108. The output unit 108 first transmits the liveness monitoring function detection logs, followed by the detection logs. Each log is transmitted in the order of generation time and reception time. Alternatively, the logs can be transmitted in the order of generation time or reception time without distinguishing between liveness monitoring function detection logs and detection logs.

The output unit 108 may also transmit information indicating the number of ECUs 10 or security sensors for which the liveness monitoring function detection logs are relevant. In the case of FIG. 11, there are four transmission sources identified by ECU 10a to ECU 10d, so the number of ECUs/SSs is 4.

The output unit 108 may further transmit the generation time of the liveness monitoring function detection logs and the reception time of the detection logs linked to each log. In the case of FIG. 11, the time information indicating the generation time and reception time is transmitted immediately after each log.

In this embodiment, since the liveness monitoring function detection logs are transmitted, the liveness monitoring logs received by the liveness monitoring log reception unit 102 are not transmitted to the log analysis device 20.

The output unit 108 transmits the liveness monitoring function detection logs and detection logs proactively. However, the output unit 108 may also transmit the liveness monitoring function detection logs and detection logs in response to a request from the log analysis device 20.

### (2) Operation of the Log Management Device 100

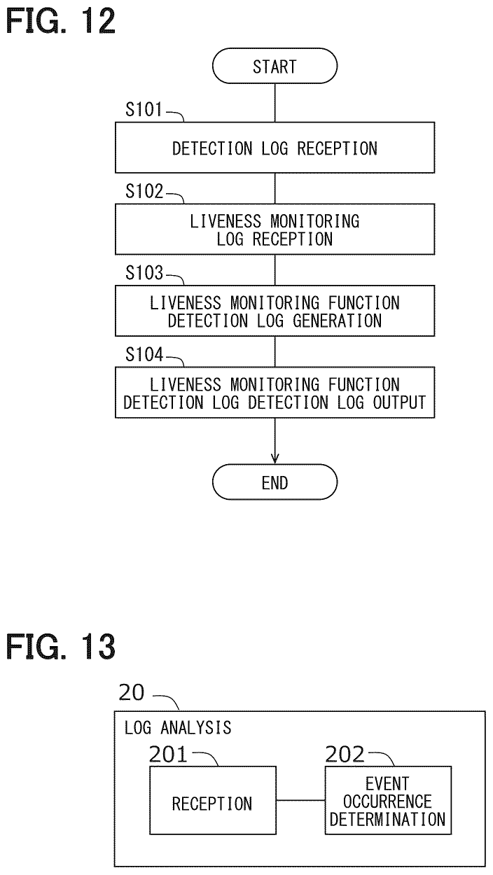

Next, the operation of the log management device 100 will be described with reference to FIG. 12. FIG. 12 not only shows the log management method executed by the log management device 100 but also illustrates the processing steps of the log management program executable by the log management device 100. These processes are not limited to the order shown in FIG. 12. That is, unless there is a constraint such as the need to use the result of a preceding step in a subsequent step, the order can be rearranged. The same applies to other embodiments.

The detection log reception unit 101 receives detection logs indicating the detection results of the security sensors of the ECU 10 installed in the vehicle (S101). The liveness monitoring log reception unit 102 receives liveness monitoring logs indicating that the security sensors are operating (S102). Based on the reception status of the liveness monitoring logs received in S102, the liveness monitoring function detection log generation unit 105 generates liveness monitoring function detection logs indicating the operation start and operation stop of the security sensors (S103). The output unit 108 outputs the liveness monitoring function detection logs generated in S103 and the detection logs received in S101 during the first period (S104).

### (3) Configuration and Operation of the Log Analysis Device 20

FIG. 13 is a block diagram showing the configuration of the log analysis device 20 in this embodiment. The log analysis device 200 includes a reception unit 201 and an event occurrence determination unit 202.

The reception unit 201 receives the liveness monitoring function detection logs and detection logs transmitted from the log management device 100.

The event occurrence determination unit 202 uses the liveness monitoring function detection logs and detection logs received by the reception unit 201 to determine the occurrence of events in the ECU or security sensors. In this embodiment, in particular, the event occurrence determination unit 202 determines the occurrence or possibility of events based on the combination of whether the liveness monitoring function detection log is an operation start detection log or an operation stop detection log, and the presence or absence of detection logs.

Using FIG. 10B, the method for determining the occurrence of events in the ECU or security sensors will be explained. As previously described, the log management device 100 transmits the liveness monitoring function detection logs and detection logs shown in FIG. 10A, and the log analysis device 20 receives these logs.

According to FIG. 10B, the ECUs 10a to 10d can be determined as follows based on the type of liveness monitoring function detection log and the presence or absence of detection logs.

ECU 10a generates an operation start detection log and does not generate detection logs during the grouping period. This means that the security sensor is operating, but since the normally operating security sensor has not detected any abnormal events, it can be evaluated that no abnormal events have occurred. Therefore, it can be determined that no events have occurred in ECU 10a.

ECU 10b generates an operation stop detection log and does not generate detection logs during the grouping period. This means that the security sensor is not operating and thus does not generate detection logs, but it can be evaluated that there is a possibility that an abnormal event has occurred. Therefore, it can be determined that there is a possibility of an event occurring in ECU 10b.

ECU 10c generates an operation start detection log and generates detection logs during the grouping period. This means that the security sensor is operating and the normally operating security sensor has detected an abnormal event. Therefore, it can be determined that an event has occurred in ECU 10c.

ECU 10d generates an operation stop detection log and generates detection logs during the grouping period. This means that although the security sensor is not operating, detection logs are being generated. It can be evaluated that the normally operating security sensor has detected an abnormal event. Therefore, it can be determined that an event has occurred in ECU 10d. However, it can also be determined that there may be some malfunction in the function of generating liveness monitoring function detection logs or in the function of sending and receiving liveness monitoring logs.

### (4) Overview

As described above, according to this embodiment, the liveness monitoring function detection logs indicating the operation start and operation stop of the security sensors are generated based on the reception status of the liveness monitoring logs and transmitted to the log analysis device. This provides the log analysis device with information regarding the operation of the security sensors, allowing the log analysis device to determine the occurrence of events in the ECU or security sensors based on this information. Additionally, since the liveness monitoring function detection logs are transmitted, there is no need to transmit the liveness monitoring logs, thereby reducing the communication volume between the log management device and the log analysis device.

According to this embodiment, since two types of logs, the operation stop detection log and the operation start detection log, are generated and transmitted as liveness monitoring function detection logs, the log analysis device can make more detailed determinations regarding the occurrence of events using information that directly indicates the operation of the security sensors.

According to this embodiment, since the grouping period is set based on the trigger time, detection logs related to cyberattacks can be widely collected and provided to the log analysis device. In particular, since the grouping period includes the period before and after the trigger time, detection logs indicating the precursors of cyberattacks and those affected by cyberattacks can be provided to the log analysis device, enabling the log analysis device to accurately identify cyberattacks and take appropriate countermeasures.

According to this embodiment, since the most recent liveness monitoring function detection log generated before the trigger time is transmitted, the liveness monitoring function detection log that most reflects the operation status of the security sensors during the grouping period can be provided to the log analysis device.

According to this embodiment, since the liveness monitoring function detection logs generated during the grouping period are transmitted, information indicating changes in the operation status of the security sensors during the grouping period can be provided to the log analysis device.

According to this embodiment, since the liveness monitoring function detection logs and detection logs are transmitted proactively, information can be quickly provided to the log analysis device in situations where the possibility of a cyberattack is high, enabling the log analysis device to promptly identify cyberattacks and take appropriate countermeasures.

### 3. Second Embodiment

In the first embodiment, the log management device 100 sets the grouping period based on the trigger time and targets the most recent liveness monitoring function detection log generated before the trigger time for transmission. In the log management device 200 of this embodiment, the transmission target is determined by focusing on the trip period defined based on changes in the vehicle's power state. For example, the trip period can be from the ignition (IG) ON to OFF. Another example of a trip period is the period from the accessory power ON to OFF, but of course, other power states can also be used.

Alternatively, the transmission target can be determined by focusing on regular periods such as 24 hours or 5 days, or periods specified by the usage period of any function installed in the vehicle. In such cases, since security logs cannot be received or generated when the vehicle's power is OFF, these periods can be considered as trip periods. Even if these periods span multiple trip periods, each can still be considered a trip period.

### (1) Configuration of the Log Management Device 200

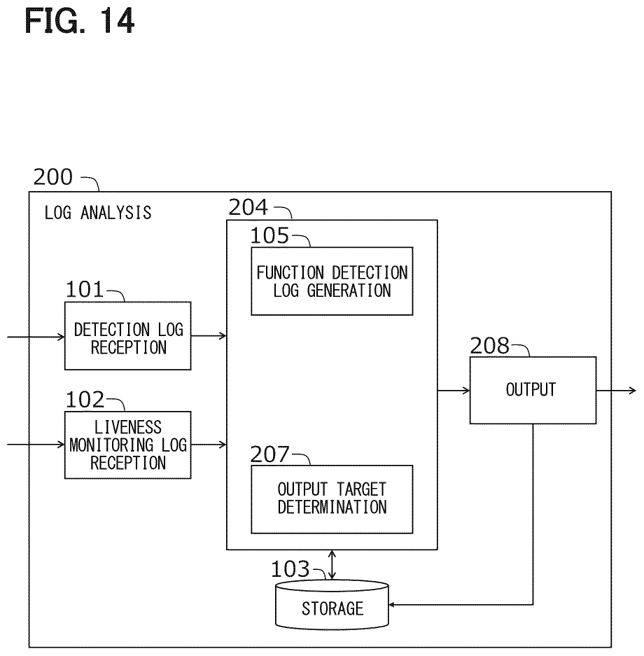

FIG. 14 is a block diagram showing the configuration of the log management device 200 in this embodiment. The same configuration as the log management device 100 of the first embodiment uses the same reference numbers as in FIG. 6, and the description and drawings of the first embodiment are referenced. The log management device 200 includes a detection log reception unit 101, a liveness monitoring log reception unit 102, a storage unit 103, a control unit 204, and an output unit 208. The control unit 204 implements the liveness monitoring function detection log generation unit 105 and the output target determination unit 207 using hardware and/or software.

The output target determination unit 207 determines the range of security logs to be output by the output unit 208. As in the first embodiment, the output destination is either the log analysis device 20 or the storage unit 103. In the former case, the transmission target is determined. In the latter case, the storage target is determined. This embodiment is described using the example of transmission to the log analysis device 20, but the operation when outputting to the storage unit 103 is fundamentally the same.

In this embodiment, the output target determination unit 207 sets the trip period (corresponding to the “first period”) from the vehicle's IG-ON to OFF as the temporal range of the detection logs to be transmitted.

The output target determination unit 207 then determines the liveness monitoring function detection logs generated by the liveness monitoring function detection log generation unit 105 and the detection logs received by the detection log reception unit 101 during the trip period as the security logs to be transmitted by the output unit 208. In this embodiment, the liveness monitoring function detection logs to be transmitted are those generated during the trip period.

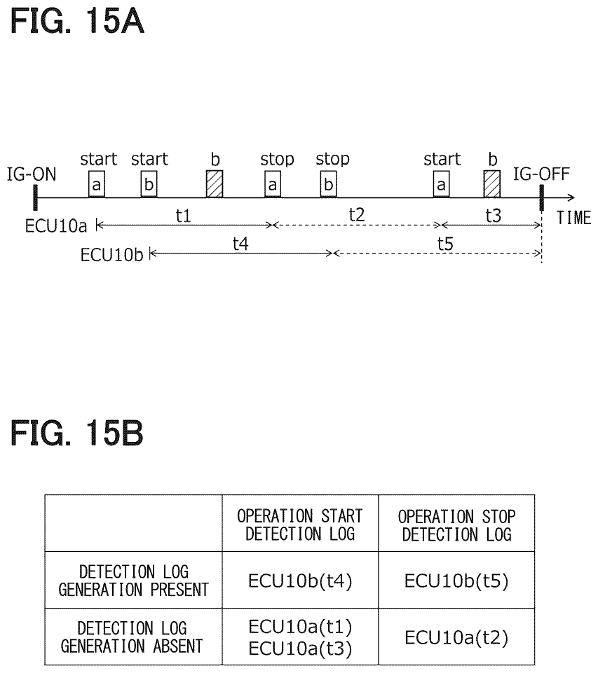

FIG. 15A is an example of the security logs to be transmitted when there are two ECUs, ECU 10a and ECU 10b. In the figure, the operation start detection logs among the liveness monitoring function detection logs are labeled as “start,” and the operation stop detection logs are labeled as “stop.” The letters “a” and “b” attached to the liveness monitoring function detection logs and detection logs indicate which ECU generated the logs.

In FIG. 15A, during the trip period, the operation start detection log a of ECU 10a, the operation start detection log b of ECU 10b, the operation stop detection log a of ECU 10a, the operation stop detection log b of ECU 10b, and the operation start detection log a of ECU 10a are generated in chronological order. Therefore, these liveness monitoring function detection logs are determined as the transmission targets. Additionally, the detection logs received during the trip period are also determined as transmission targets. In FIG. 15A, the detection logs included in the trip period are the two detection logs received from ECU 10b. FIG. 15B will be described later as a function of the log analysis device 20.

Returning to FIG. 14, the output unit 208 transmits the security logs determined by the output target determination unit 207 to the log analysis device 20. In this embodiment, the liveness monitoring function detection logs and the detection logs received during the trip period (corresponding to the “first period”) are transmitted.

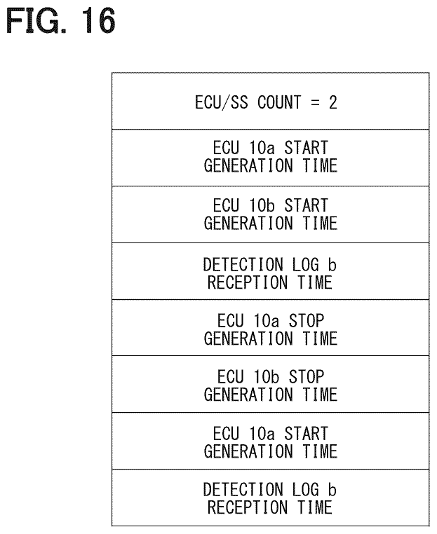

FIG. 16 is an example of the information transmitted by the output unit 208. The output unit 208 transmits the liveness monitoring function detection logs and detection logs. In this embodiment, there is no distinction in the transmission order of the liveness monitoring function detection logs and detection logs; they are transmitted in the order of their generation time or reception time. The output unit 208 may also transmit information indicating the number of ECUs 10 or security sensors that are the subject of the liveness monitoring function detection logs to be transmitted. In the case of FIG. 11, there are two transmission sources identified by ECU 10a and ECU 10b, so the number of ECUs/SSs is two. The output unit 208 may further transmit the generation time of the liveness monitoring function detection logs and the reception time of the detection logs linked to each log. In the case of FIG. 16, the time information indicating the generation time and reception time is transmitted immediately after each log.

In this embodiment, since the liveness monitoring function detection logs are transmitted, the liveness monitoring logs received by the liveness monitoring log reception unit 102 are not transmitted to the log analysis device 20.

The output unit 208 transmits the liveness monitoring function detection logs and detection logs in response to requests from the log analysis device 20. For example, it transmits the liveness monitoring function detection logs and detection logs for one or more trip periods included in the past 10 days collectively. However, the output unit 208 may also proactively transmit the liveness monitoring function detection logs and detection logs.

### (2) Operation of the Log Management Device 200

The operation of the log management device 200 is the same as that of the log management device 100, so FIG. 12 and its description are referenced.

### (3) Configuration and Operation of the Log Analysis Device 20

The configuration of the log analysis device 20 in this embodiment is the same as that of the log analysis device 20 in the first embodiment, so FIG. 13 and its description are referenced.

Using FIG. 15A and FIG. 15B, the method for detecting abnormalities in the security sensors will be explained. As previously described, the log management device 200 transmits the liveness monitoring function detection logs and detection logs shown in FIG. 15A, and the log analysis device 20 receives these logs.

According to FIG. 15B, the ECUs 10a to 10b can be determined as follows based on the type of liveness monitoring function detection log and the presence or absence of detection logs.

ECU 10a generates an operation start detection log at the beginning of the t1 period and the t3 period and does not generate detection logs during these periods. This means that the security sensor is operating, but since the normally operating security sensor has not detected any abnormal events, it can be evaluated that no abnormal events have occurred. Therefore, it can be determined that no events have occurred in ECU 10a.

ECU 10a generates an operation stop detection log at the beginning of the t2 period and does not generate detection logs during the t2 period. This means that the security sensor is not operating and thus does not generate detection logs, but it can be evaluated that there is a possibility that an abnormal event has occurred. Therefore, it can be determined that there is a possibility of an event occurring in ECU 10a.

ECU 10b generates an operation start detection log at the beginning of the t4 period and generates detection logs during the t4 period. This means that the security sensor is operating and the normally operating security sensor has detected an abnormal event. Therefore, it can be determined that an event has occurred in ECU 10b.

ECU 10b generates an operation stop detection log at the beginning of the t5 period and generates detection logs during the t5 period. This means that although the security sensor is not operating, detection logs are being generated. It can be evaluated that the normally operating security sensor has detected an abnormal event. Therefore, it can be determined that an event has occurred in ECU 10b. However, it can also be determined that there may be some malfunction in the function of generating liveness monitoring function detection logs or in the function of sending and receiving liveness monitoring logs.

### (4) Overview

As described above, according to this embodiment, the liveness monitoring function detection logs indicating the operation start and operation stop of the security sensors are generated based on the reception status of the liveness monitoring logs and transmitted to the log analysis device. This provides the log analysis device with information regarding the operation of the security sensors, allowing the log analysis device to determine the occurrence of events in the ECU or security sensors based on this information. Additionally, since the liveness monitoring function detection logs are transmitted, there is no need to transmit the liveness monitoring logs, thereby reducing the communication volume between the log management device and the log analysis device.

According to this embodiment, since two types of logs, the operation stop detection log and the operation start detection log, are generated and transmitted as liveness monitoring function detection logs, the log analysis device can make more detailed determinations regarding the occurrence of events using information that directly indicates the operation of the security sensors.

According to this embodiment, since the trip period is set, detection logs related to cyberattacks can be widely collected and provided to the log analysis device.

According to this embodiment, since the liveness monitoring function detection logs generated during the trip period are transmitted, the log analysis device can be provided with information indicating changes in the operation status of the security sensors during the trip period.

According to this embodiment, since the liveness monitoring function detection logs and detection logs are transmitted in response to requests from the log analysis device, only the security logs deemed necessary by the log analysis device are transmitted, thereby reducing the communication volume.

### 4. General Overview

The features of the log management device and other components in each embodiment of the present disclosure have been described above.

The terms used in each embodiment are illustrative and may be replaced with synonymous terms or terms that include synonymous functions. Each element, function, step or the like described in the embodiments and the disclosure may be in the plural or singular form, as long as no technical contradictions or issues arise. Furthermore, these elements, functions, steps or the like can be combined and used as appropriate.

The block diagrams used in the description of the embodiments classify and organize the configuration of the device by function. The blocks indicating each function can be realized by any combination of hardware or software. Since they indicate functions, these block diagrams can also be understood as disclosures of a method disclosure and a program disclosure that realizes the method.

The processing, flow, and function blocks that can be understood as methods described in each embodiment may have their order rearranged unless there are constraints such as a relationship where one step uses the result of another preceding step.

The terms “first,” “second,” up to “N” (where N is an integer) used in each embodiment and the disclosure are used to distinguish two or more similar configurations or methods and do not limit the order or superiority.

Examples of forms of the log management device of the present disclosure include the following forms. Examples of forms of components include semiconductor devices, electronic circuits, modules, and microcomputers. Examples of forms of semi-finished products include electronic control units (ECUs), and system boards. Examples of forms of finished products include mobile phones, smartphones, tablets, personal computers (PCs), workstations, and servers. Other devices with communication functions can also be included, such as video cameras, still cameras, and car navigation systems.

Additionally, necessary functions such as antennas and communication interfaces may be added to the log management device.

The log management device of the present disclosure is particularly envisaged to be used on the server side to provide various services. With the provision of such services, the log management device of the present disclosure will be used, the method of the present disclosure will be used, and/or the program of the present disclosure will be executed.

Furthermore, the present disclosure can be realized not only with dedicated hardware having the configuration and functions described in each embodiment but also as a combination of a program recorded on a recording medium such as memory or a hard disk to realize the present disclosure, and general-purpose hardware having a dedicated or general-purpose CPU and memory that can execute this program.

The program stored on a non-transitory tangible recording medium of dedicated or general-purpose hardware (for example, external storage devices such as hard disks, USB memory, CDs/BDs, or internal storage devices such as RAM, ROM) can be provided to dedicated or general-purpose hardware via a communication line from a server, either through or without a recording medium. This allows the latest functions to be provided through program upgrades.

The log management device of the present disclosure is primarily intended for analyzing cyberattacks received by electronic control systems mounted on vehicles, but it may also be intended for analyzing attacks on ordinary systems not mounted on vehicles.

What is claimed is:

1. A log management device comprising:
a detection log reception unit configured to receive a detection log indicating a detection result of a security sensor of an electronic control unit mounted on a vehicle;
a liveness monitoring log reception unit configured to receive a liveness monitoring log indicating that the security sensor is operating;
a liveness monitoring function detection log generation unit configured to generate a liveness monitoring function detection log indicating an operation start and an operation stop of the security sensor based on a reception status of the liveness monitoring log; and
an output unit configured to output the liveness monitoring function detection log and the detection log received during a first period.

2. The log management device according to claim 1, wherein
the liveness monitoring function detection log generation unit
generates an operation stop detection log, which is the liveness monitoring function detection log, when the liveness monitoring log is not received during a second period, and
generates an operation start detection log, which is the liveness monitoring function detection log, when the liveness monitoring log is first received or when the liveness monitoring log is received again after generation of the operation stop detection log.

3. The log management device according to claim 1, wherein
the output unit outputs the liveness monitoring function detection log and the detection log for each electronic control unit or each security sensor.

4. The log management device according to claim 1, wherein
the output unit further transmits information indicating a total number of electronic control units or security sensors that are subjects of the liveness monitoring function detection log.

5. The log management device according to claim 1, wherein
the output unit transmits the detection log after the liveness monitoring function detection log.

6. The log management device according to claim 1, wherein
the output unit further transmits time information indicating a time at which the liveness monitoring function detection log has been generated.

7. The log management device according to claim 1, wherein
the output unit refrains from transmitting the liveness monitoring log to a log analysis device.

8. The log management device according to claim 1, further comprising
a threat detection unit configured to determine whether one or more of the detection logs received by the detection log reception unit meet a predetermined condition,
wherein
the first period is set based on a trigger time, which is a reception time of the detection log that meets the predetermined condition.

9. The log management device according to claim 8, wherein
the first period includes the period before and after the trigger time.

10. The log management device according to claim 9, wherein
the output unit outputs a most recent liveness monitoring function detection log generated before the trigger time.

11. The log management device according to claim 9, wherein
the output unit outputs the liveness monitoring function detection log generated during the first period as the detection log.

12. The log management device according to claim 10, wherein
the output unit spontaneously transmits the liveness monitoring function detection log and the detection log to a log analysis device.

13. The log management device according to claim 8, wherein
the liveness monitoring function detection log generation unit generates an operation stop detection log, which is the liveness monitoring function detection log, when the liveness monitoring log fails to be received during a second period, and
the second period is longer than the first period.

14. The log management device according to claim 1, wherein
the first period is a trip period defined based on a change in a power state of the vehicle.

15. The log management device according to claim 14, wherein
the output unit outputs the liveness monitoring function detection log generated during the first period as the detection log.

16. The log management device according to claim 15, wherein
the output unit transmits the liveness monitoring function detection log and the detection log to a log analysis device in response to a request from the log analysis device.

17. The log management device according to claim 1, wherein
the log management device is mounted on the vehicle.

18. The log management device according to claim 1, wherein
the log management device is provided outside the vehicle.

19. A log management method executed by a log management device, the log management method comprising:
receiving a detection log indicating a detection result of a security sensor of an electronic control unit mounted on a vehicle;
receiving a liveness monitoring log indicating that the security sensor is operating;
generating a liveness monitoring function detection log indicating an operation start and an operation stop of the security sensor based on a reception status of the liveness monitoring log; and
outputting the liveness monitoring function detection log and the detection log received during a first period.

20. A non-transitory computer readable storage medium storing a log management program executable by a log management device, wherein the log management program causes the log management device to:
receive a detection log indicating a detection result of a security sensor of an electronic control unit mounted on a vehicle;
receive a liveness monitoring log indicating that the security sensor is operating;
generate a liveness monitoring function detection log indicating an operation start and an operation stop of the security sensor based on a reception status of the liveness monitoring log; and
output the liveness monitoring function detection log and the detection log received during a first period.

21. A log management system comprising:
a log management device; and
a log analysis device,
wherein
the log management device includes:
a detection log reception unit that receives a detection log indicating a detection result of a security sensor of an electronic control unit mounted on a vehicle;
a liveness monitoring log reception unit that receives a liveness monitoring log indicating that the security sensor is operating;
a liveness monitoring function detection log generation unit that generates a liveness monitoring function detection log including an operation start detection log indicating an operation start of the security sensor and an operation stop detection log indicating an operation stop of the security sensor based on a reception status of the liveness monitoring log; and
an output unit that outputs the liveness monitoring function detection log and the detection log received during a first period, and
the log analysis device includes:
a reception unit that receives the liveness monitoring function detection log and the detection log; and
an event occurrence determination unit that determines the occurrence of an event in the electronic control unit or the security sensor based on a combination of whether the liveness monitoring function detection log is the operation start detection log or the operation stop detection log, and presence or absence of the detection log.
